(19) United States
(12) Patent Application Publication
(10) Pub. No.: US 2006/0229775 A1
(43) Pub. Date: Oct. 12, 2006

(54) Mobile navigator

(75) Inventors: Li-Sen Chen, Gueishan Township (TW); Chien-Yu Hsu, Gueishan Township (TW); Chang-Yi Li, Gueishan Township (TW)

Correspondence Address: TROXELL LAW OFFICE PLLC, SUITE 1404, 5205 LEESBURG PIKE, FALLS CHURCH, VA, 22041, US

(73) Assignee: Speed Tech Corp.

(21) Appl. No.: 11/377,344

(22) Filed: Mar. 17, 2006

(30) Foreign Application Priority Data
Apr. 8, 2005 (TW) 094205482

(51) Int. Cl. G05D 1/00

(52) U.S. Cl. 701/23

(57) ABSTRACT

Terminals in a navigator for a mobile phone are easily installed in the present invention. The terminals not only transfer signals but also strengthen the structure of the navigator after assembling the terminals into a supportive frame.

### FIELD OF THE INVENTION

The present invention relates to a navigator; more particularly, relates to communicating signals with a structure of terminals while keeping a specific attitude of the navigator.

### DESCRIPTION OF THE RELATED ART

A general navigator for a mobile phone, as shown in FIG. 6 and FIG. 7 has terminals 4, where each terminal 4 has a contactor 41 deposed with a U-turn part 42 at a side; the U-turn part 42 is connected with the contactor 41 through a connecting part 43; a slot 44 is located between the connecting part 43 and the contact or 41; the connecting part 43 has a locking part 45 bending downward straightly at a side to be located in the slot 44; and the terminal 4 is locked to a support 2 through the locking part 45.

Although the terminal 4 is locked to the support 2 through the locking part 45, because the terminal 4 is a metal plate with a small size, the locking part 45 is hard to be fabricated. Besides, the terminal for electronically connecting two electric parts in the mobile phone is made of an elastic metal, so that it is hard to fabricate the locking part 45 bended with a specific angle corresponding to the support 2. In addition, the locking part 45 is bended vertically after being fabricated, so that it is not easy to be assembled to the support 2; and, the locking part 45 may be changed with its original angle to the support 2 by a sudden hit of an outside force. Hence, the prior art does not fulfill users requests on actual use.

### SUMMARY OF THE INVENTION

The main purpose of the present invention is to improve the fabrication process and assembly process of terminals of a mobile navigator.

To achieve the above purpose, the present invention is a mobile navigator, comprising an encoder unit, a support and a plurality of terminal, where the encoder unit is a hollow cylinder; the support has two braces and each brace has a plate deposed reversely to each other; each terminal has a contactor to be electronically connected with the encoder unit and the contactor of the terminal has a connecting part adhered to the plate of the support; the connecting part of the terminal has a supporting element extending toward the brace of the support; the supporting element is parallel to the connecting part of the terminal; and the brace of the support has a containing slot for the supporting element of the terminal to be plugged in.

Because the connecting part of the terminal has a supporting element extending toward the brace of the support, the supporting element not only transfers signals but also improve the fabrication process and assembly process of the terminals of the mobile navigator according to the present invention. Accordingly, a novel mobile navigator is obtained.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is a perspective view showing a preferred embodiment according to the present invention;

FIG. 2 is an explosive view showing the preferred embodiment according to the present invention;

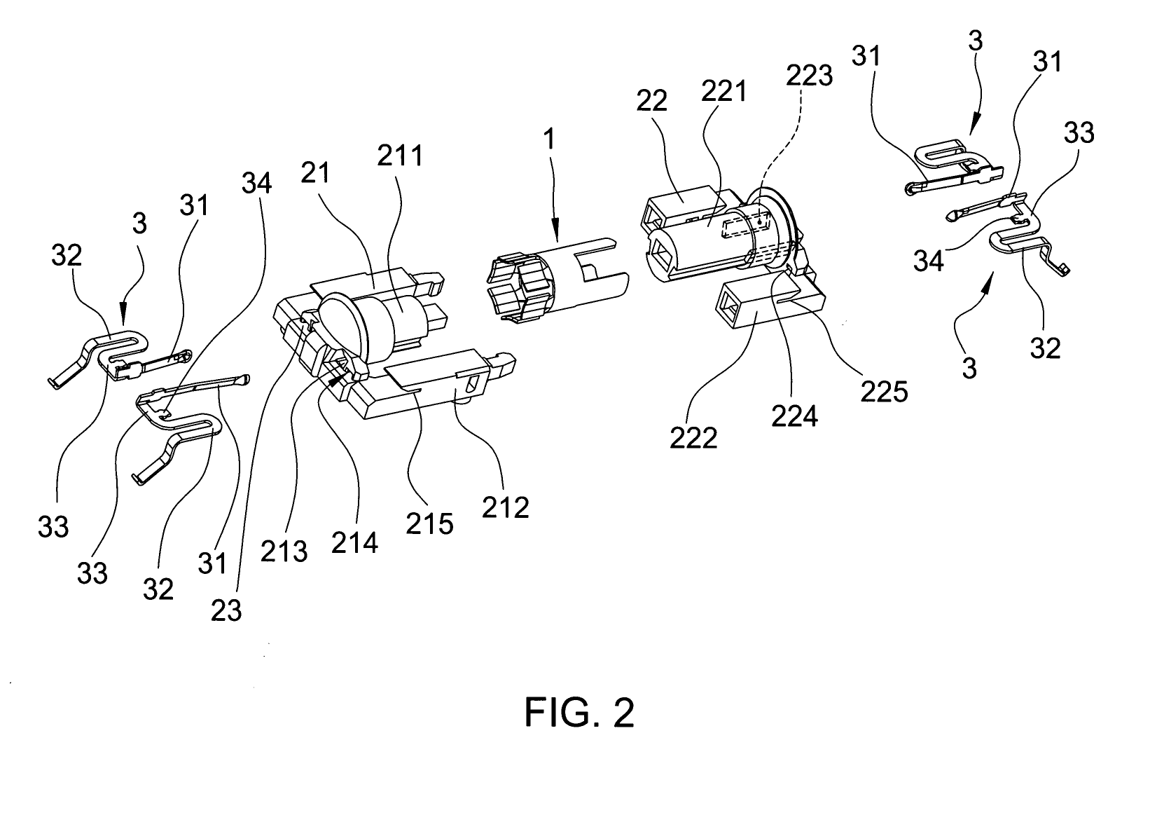

FIG. 3 is a perspective view showing a terminal according to the preferred embodiment of the present invention;

FIG. 4 is a view showing an assembling of the preferred embodiment according to the present invention;

FIG. 5 is a view showing an enlargement of ‘A’ of FIG. 3 according to the preferred embodiment of the present invention;

FIG. 6 is a perspective view of a terminal of a prior art; and

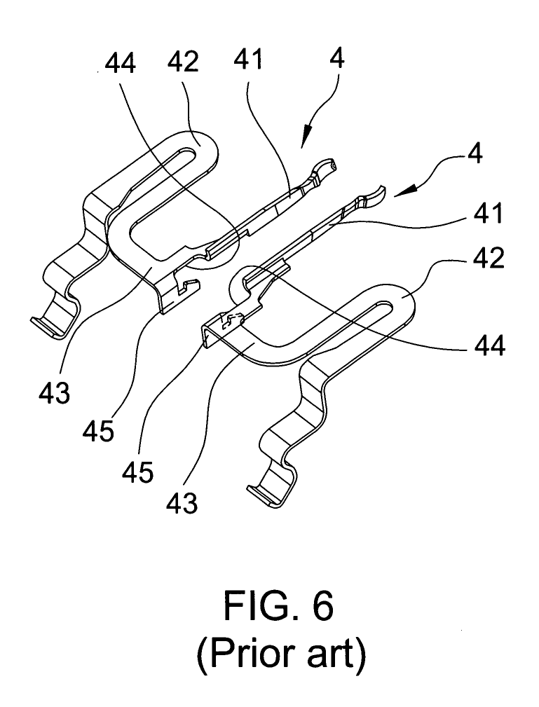

FIG. 7 is another perspective view of the terminal of the prior art.

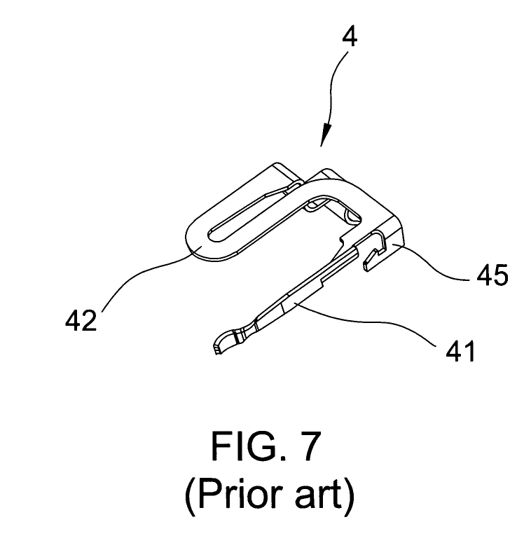

### DESCRIPTION OF THE PREFERRED EMBODIMENT

The following description of the preferred embodiment is provided to understand the features and the structures of the present invention.

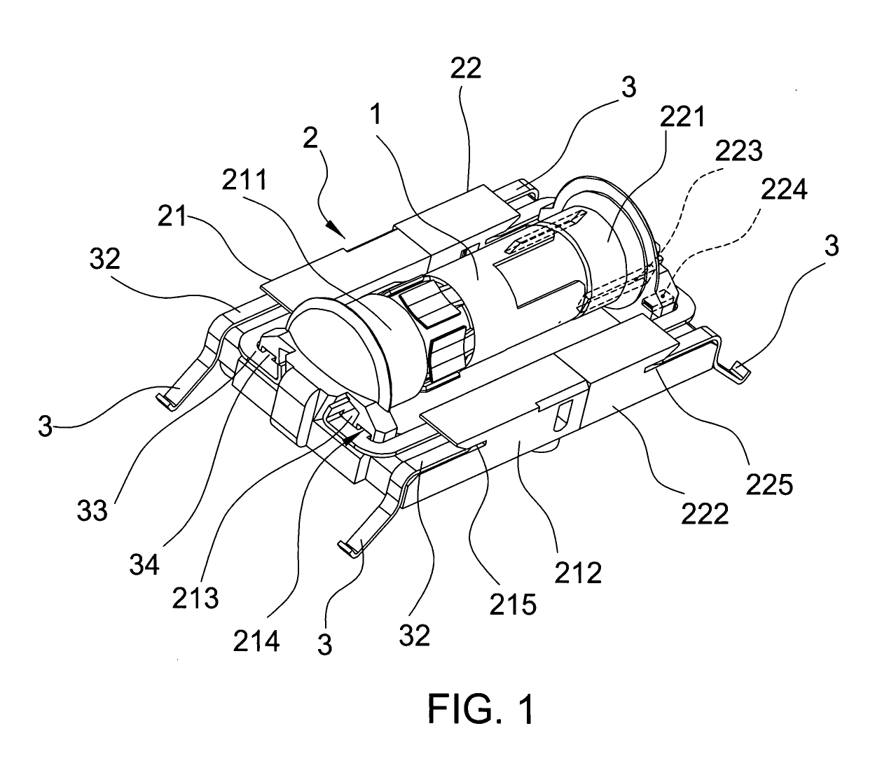

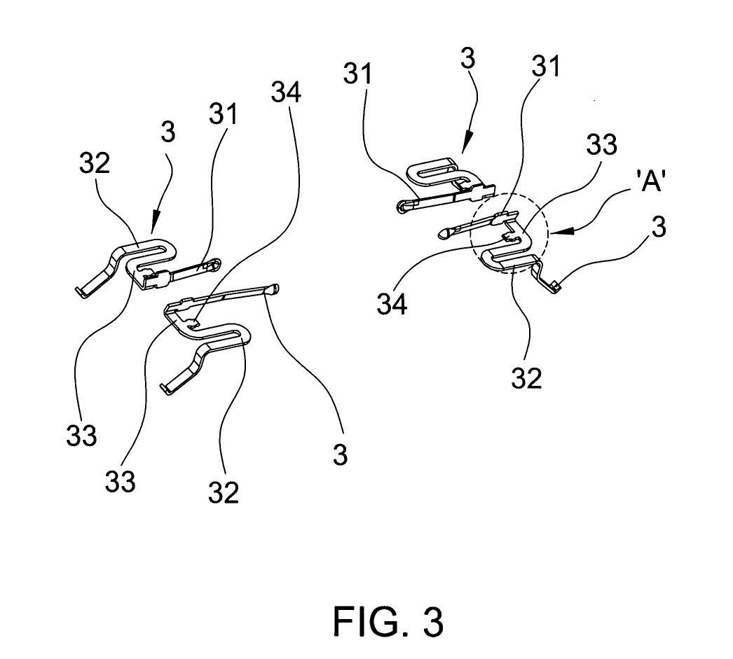

Please refer to FIG. 1 till FIG. 3, which are a perspective and an explosive views showing a preferred embodiment and a perspective view showing a terminal of the preferred embodiment, according to the present invention. As shown in the figures, the present invention is a mobile navigator, deposed on a circuit board (not shown in the figures), comprising an encoder unit 1, a support 2 and a plurality of terminals 3, where the terminal 3 has a supporting element 34 easily deposed on the support 2 and the supporting element 34 is easily fabricated; the terminal 3 and the support 2 are assembled to keep the present invention with a certain attitude; and the encoder unit 1 is a hollow cylinder.

The support 2 comprises two braces 21,22 each respectively having a plate deposed reversely; a shaft 211,221 is located at the middle of each brace 21,22 for the encoder unit 1 to slip over; a cantilever beam 212,222 is deposed at a side of each shaft 211,221; two sides at both ends of the shafts 211,221 respectively have containing slots 213,223; a fixing hole 214,224 is respectively located at a side near each containing slot 213,223; and, a locking slot 215,225 is deposed on a surface of each cantilever beam 212,222.

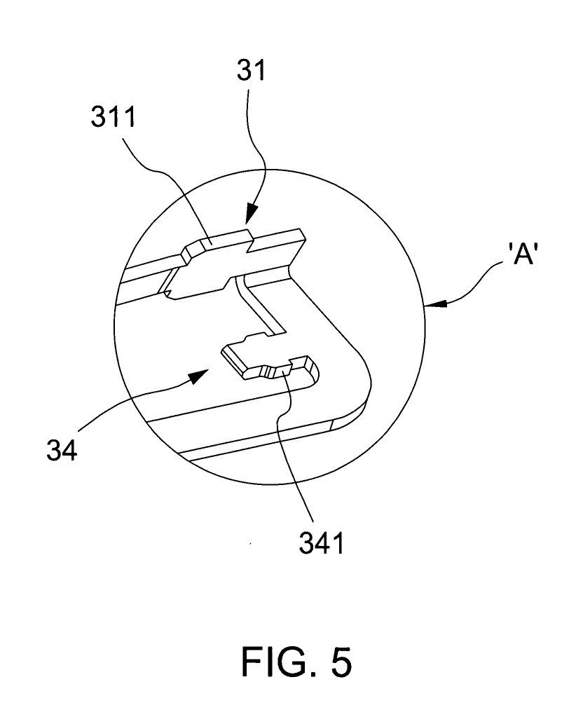

The terminals 3 are fixed on the support 2; each terminal 3 has a contactor 31 with a connecting part 33 and a U-turn part 32 at a side the U-turn part 32 is connected with the contactor 31 through the connecting part 33; the contactor 31 is inserted into the encoder unit 1 to be connected with the inner surface of the encoder unit 1; the connecting part 33 is adhered to the plate 23; a supporting element 34 is deposed correspondingly at a side of the connecting part 33; the supporting element 34 is parallel to the connecting part 33 and both are deposed at the end of the connecting part 33 in to a whole; two sides of the supporting element 34 have respectively interfering parts 341 (as shown in FIG. 5); the interfering part 341 is deposed at each side of the supporting element 34 into a whole, shaped as a hook; and, the terminal 3 is correspondingly fixed into the fixing hole 214,224 with the supporting element 34. By doing so, the terminal 3 can be easily fabricated and be deposed on the support 2 with good supporting strength, where the terminal 3 is electronically connected with the encoder unit 1 through the contactor 31 and is electronically connected with the circuits of the electronic device through the U-turn part 32 of the connecting part 33.

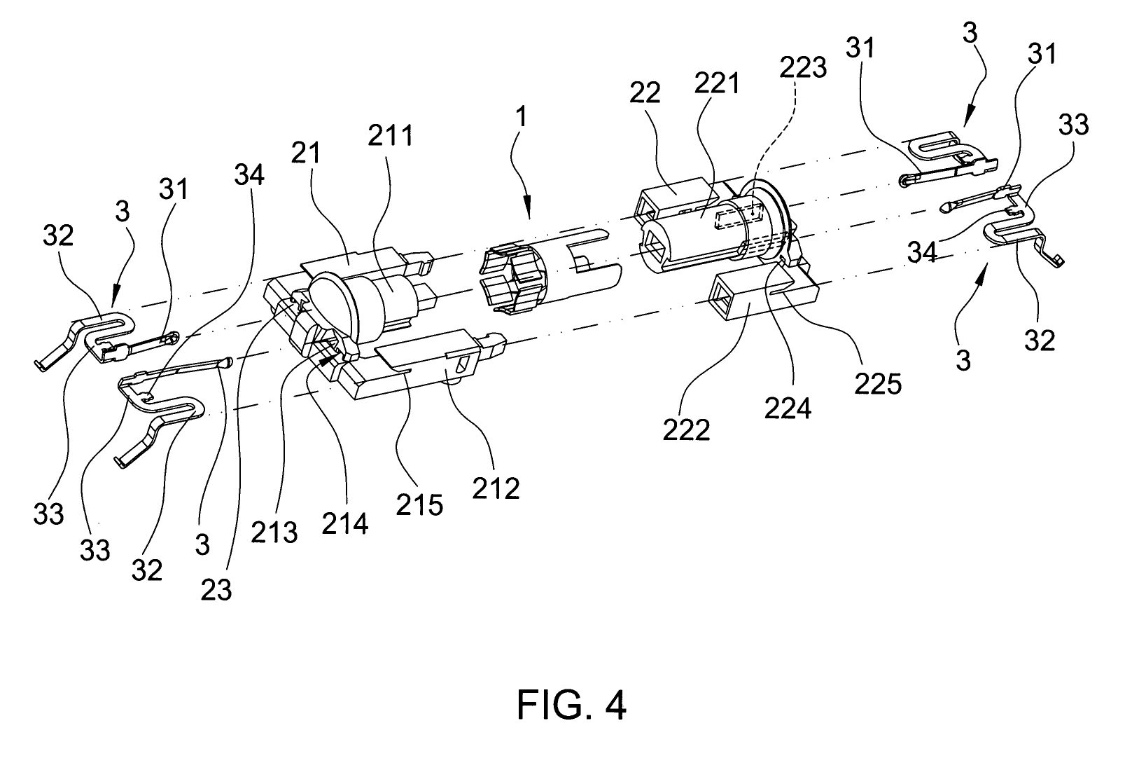

Please refer to FIG. 4, which is a view showing an assembling of the preferred embodiment according to the present invention. As shown in the figure, when assembling terminals 3, contactors 31 are plugged into containing slots 213,223 with supporting elements 34 plugged into fixing holes 214,224 to be in contact with inner surfaces of an encoder unit 1; interfering parts 341 at two sides of a supporting element 34 are interfered with two inner surfaces of the fixing hole 214,224 to firmly fixing the supporting element 34 in the fixing hole 214,224; and, U-turn parts 32 are plugged into the locking slots 215,225 or are connected with braces 21,22 in another way, so that a strong support is obtained after assembling the terminal 3 and the braces 21,22.

When the mobile navigator according to the present invention is pressed toward a circuit board by a force from a user, the mobile navigator is deformed with an attitude changed. Because the supporting elements 34 a replugged into the fixing holes 214,224, when the attitude of the mobile navigator is changed, at least a part of the terminals are deformed. A potential of the mobile navigator for returning to the original attitude is obtained from the resilience formed by the deformation of the terminal 3, so that, after removing the force from the user, the mobile navigator returns back to the original attitude.

Because the supporting element 32 of the terminal 3 is parallel to the U-turn part 32 and the supporting element 34 is extended from a side of the U-turn part and there is no change in angle between the supporting element 34 and the U-turn part on fabrication, so that no differential control to the angle between the supporting element 34 and the U-turn part 32 is required, which happens only when bending an elastic material to obtain a certain angle. Therefore, the fabrication and assembly of the present invention is improved and the production efficiency is enhanced.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A mobile navigator, comprising:
(a) an encoder unit, wherein said encoder unit is a metal hollow cylinder;
(b) a support, wherein said support has two braces and each said brace respectively has a plate deposed reversely to each other; and
(c) a plurality of terminals, wherein said terminal has a contactor, said contactor extends out a connecting part adhered to said plate, and said terminal is electronically connected with said encoder unit through said connecting part, characterized in that:
said connecting part extends out a supporting element toward said brace;
said supporting element is parallel to said connecting part
said brace has a containing slot to be plugged with said supporting element.

2. The mobile navigator according to claim 1,
wherein said brace has a locking slot, and a U-turn part of said terminal is plugged in said locking slot.

3. The mobile navigator according to claim 1,
wherein said supporting element has interfering parts and each said interfering part respectively deposed at a side of said supporting element.

4. The mobile navigator according to claim 1,
wherein said interfering parts are respectively deposed at two sides of said supporting element as a whole.

5. The mobile navigator according to claim 1,
wherein said interfering part is hook shaped.
